(19) United States
(12) Patent Application Publication
(10) Pub. No.: US 2010/0023168 A1
(43) Pub. Date: Jan. 28, 2010

(54) INTERMEDIARY DEVICE FOR AIR CONDITIONING CONTROL, AIR CONDITIONING CONTROL SYSTEM, AIR CONDITIONING CONTROL METHOD, AND AIR CONDITIONING CONTROL PROGRAM

(75) Inventors: Takashige Kai, Shiga (JP); Masaya Nishimura, Shiga (JP); Mizuki Tanaka, Shiga (JP)

Correspondence Address: GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka-shi, Osaka (JP)

(21) Appl. No.: 12/441,255

(22) PCT Filed: Sep. 13, 2007
(86) PCT No.: PCT/JP2007/067825

§ 371 Date: Mar. 13, 2009

(30) Foreign Application Priority Data
Sep. 19, 2006 (JP) 2006-253345
Aug. 31, 2007 (JP) 2007-225510

(51) Int. Cl. G05D 23/19; G05B 15/00

(52) U.S. Cl. 700/278

(57) ABSTRACT

An intermediary device for air conditioning control is connected to an air conditioning interface for generating and outputting an operation/non-operation request signal to a heat source on the basis of a room temperature and a temperature setting. The intermediary device has a receiving unit, a temperature-setting estimating unit, and a transmitting unit. The receiving unit receives the operation/non-operation request signal as input. The temperature-setting estimating unit calculates an estimated value of the temperature setting on the basis of at least the operation/non-operation request signal. The transmitting unit transmits to air conditioners the estimated value calculated in the temperature-setting estimating unit.

### TECHNICAL FIELD

The present invention relates to an intermediary device for air conditioning control, an air conditioning control system, an air conditioning control method, and an air conditioning control program.

### BACKGROUND ART

Conventionally, air conditioning for an entire building is often carried out, particularly in European and American homes, using a thermostat disposed in a single location. The thermostat has a single temperature sensor and controls a heat source for air conditioning an entire building by outputting an operation/non-operation signal to the heat source (boiler, heater, or the like), a source of heat and cold, a fan, and the like disposed in a basement or the like on the basis of a room temperature measured by the sensor and a fixed temperature set in advance. Air conditioning is performed by delivering warm air or cool air generated by the heat source to each room by way of ductwork. However, in such an air conditioning system, there is no consideration given to the heat load conditions (the amount of sunlight, and the heat load or the like produced by indoor equipment) of each room because temperature measurement is carried out in only one room that has the thermostat. In view of the above, a room-by-room air conditioning scheme using separate dispersed air conditioners has been proposed as a scheme for providing an air conditioning environment in which consideration is given to the heat load conditions of each room.

### DISCLOSURE OF THE INVENTION

### <Technical Problem>

However, in areas such as Europe and America in particular, where the use of a thermostat is the de-facto standard for a man-machine interface for air conditioners, it is difficult to introduce a completely new air conditioning system. Temperature setting information in relation to the heat source must furthermore be acquired for air conditioning control in order to introduce separate dispersed air conditioners, but the temperature setting information cannot be directly obtained from an existing thermostat.

In view of the above, an object of the present invention is to provide a pleasant air conditioning environment in response to an air conditioning load imbalance in the implementation of separate air conditioning by making use of an existing air conditioning interface for central air conditioning, such as a thermostat.

### <Solution to Problem>

An intermediary device according to a first aspect of the present invention is an intermediary device for air conditioning control, the device being connected to an air conditioning interface for outputting an operation/non-operation request signal to a heat source on the basis of a room temperature and a temperature setting, the device including a receiving unit, a temperature-setting estimating unit, and a transmitting unit. The receiving unit receives the operation/non-operation request signal as input. The temperature-setting estimating unit calculates an estimated value of the temperature setting on the basis of at least the operation/non-operation request signal. The transmitting unit transmits to air conditioners the estimated value calculated in the temperature-setting estimating unit. As used herein, the air conditioning interface refers to a user interface device used for controlling a central air conditioning apparatus, such as a thermostat.

Separate air conditioners can thereby be introduced using an air conditioning interface for existing central air conditioning, and a pleasant air conditioning environment can be provided in response to an imbalance in the air conditioning load.

An intermediary device according to a second aspect of the present invention is the intermediary device according to the first aspect of the present invention, wherein a room temperature acquisition unit is provided for acquiring the room temperature, and the temperature-setting estimating unit calculates the estimated value of the temperature setting using the room temperature and the operation/non-operation request signal.

An intermediary device according to a third aspect of the present invention is the intermediary device according to the second aspect of the present invention, wherein the room temperature acquisition unit acquires the room temperature via indoor units constituting the air conditioners. As used herein, the acquisition of the room temperature from the indoor units is referred to as the acquisition of the room temperature information from a temperature sensor or the like in the indoor units via a communication line or the like.

An intermediary device according to a fourth aspect of the present invention is the intermediary device according to the first aspect of the present invention, wherein the operation/non-operation request signal is a signal for requesting operation and non-operation to a heater or a compressor of the heat source.

An intermediary device according to a fifth aspect of the present invention is the intermediary device according to the second or third aspect of the present invention, wherein the temperature-setting estimating unit calculates as the estimated value an optimum value of the room temperature in a period from the time that the operation signal is outputted to the time that the non-operation signal is outputted, or in a period from the time that the non-operation signal is outputted to the time that the operation signal is outputted. As used herein, the optimum value refers to a value that has been determined to be optimal such as the mean value, the mode value, and the representative value such as the median value.

The temperature setting actually set in the thermostat can thereby be estimated and air conditioning control can be implemented with greater precision.

An intermediary device according to a sixth aspect of the present invention is the intermediary device according to the first aspect of the present invention, including a temporary temperature setting unit for determining a temporary temperature setting; and a time measurement unit for measuring the time from the time that the operation signal is outputted to the time that the non-operation signal is outputted, or from the time that the non-operation signal is outputted to the time that the operation signal is outputted. In the intermediary device, the temperature-setting estimating unit further calculates the estimated value on the basis of the temporary temperature setting and the measured time.

The temperature setting actually set in the thermostat can thereby be estimated without obtaining the room temperature information.

An air conditioning control system according to a seventh aspect of the present invention includes the intermediary device of the first aspect of the present inventions the air conditioning interface capable of communicating with the intermediary device, and air conditioners including an outdoor unit and indoor units that receive control signals from the intermediary device. The indoor units furthermore control air conditioning on the basis of an estimated value of the temperature setting thus received.

Separate air conditioners can thereby be introduced using an air conditioning interface for existing central air conditioning, and a pleasant air conditioning environment can be provided in response to an imbalance in the air conditioning load.

An air conditioning control system according to an eighth aspect of the present invention is the air conditioning control system of the seventh aspect of the present invention, wherein the indoor units are disposed in a plurality of rooms. Also the air conditioning interface and the intermediary device are provided in accordance with the number of the indoor units disposed in the plurality of rooms, and transmit the estimated value of the temperature setting to each of the indoor units.

An air conditioning control system according to a ninth aspect of the present invention is the air conditioning control system of the seventh aspect of the present invention, wherein the indoor units are disposed in a plurality of rooms. Also, the air conditioning interface and the intermediary device transmit the estimated value of the temperature setting collectively to a plurality of the indoor units disposed in the plurality of rooms.

An air conditioning control system according to a tenth aspect of the present invention is the air conditioning control system according any one of the seventh to ninth aspects of the present invention, wherein the intermediary device measures the room temperature using a temperature sensor connected to the intermediary device or receives the room temperature measured by a temperature sensor disposed in the indoor unit.

The estimated value of the temperature setting can thereby be obtained as desired from the room temperature measured by the intermediary device or the room temperature measured by the indoor unit.

An air conditioning control method according to a eleventh aspect of the present invention is an air conditioning control method that uses an air conditioning interface for outputting an operation/non-operation request signal to a heat source on the basis of a room temperature and a temperature setting, the method including first through third steps. In the first step, the operation/non-operation request signal is received as input from the air conditioning interface. In the second step, an estimated value of the temperature setting is calculated on the basis of at least the operation/non-operation request signal. In the third step, the estimated value calculated in the second step is transmitted to the air conditioners.

Separate air conditioners can thereby be introduced using an air conditioning interface for existing central air conditioning, and a pleasant air conditioning environment can be provided in response to an imbalance in the air conditioning load.

An air conditioning control program according to a twelfth aspect of the present invention is an air conditioning control program that uses an air conditioning interface for outputting an operation/non-operation request signal to a heat source on the basis of a room temperature and a temperature setting, wherein the air conditioning control program causes the computer to execute first to third steps. In the first step, the operation/non-operation request signal is received as input from the air conditioning interface. In the second step, an estimated value of the temperature setting is calculated on the basis of at least the operation/non-operation request signal. In the third step, the estimated value calculated in the second step is transmitted to the air conditioners.

Separate air conditioners can thereby be introduced using an air conditioning interface for existing central air conditioning, and a pleasant air conditioning environment can be provided in response to an imbalance in the air conditioning load.

### <Advantageous Effects of Invention>

In the intermediary device according to the first to fourth aspects, separate air conditioners can be introduced using an air conditioning interface for existing central air conditioning, and a pleasant air conditioning environment can be provided in response to an imbalance in the air conditioning load.

In the intermediary device according to the fifth aspect, the temperature setting actually set in the thermostat can thereby be estimated and air conditioning control can be implemented with greater precision.

In the intermediary device according to the sixth aspect, the temperature setting actually set in the thermostat can thereby be estimated without obtaining the room temperature information.

The air conditioning control system according to the seventh to ninth aspects makes it possible for separate air conditioners to be introduced using an air conditioning interface for existing central air conditioning, and to provide a pleasant air conditioning environment in response to an imbalance in the air conditioning load.

In the air conditioning control system according to the tenth aspect, the estimated value of the temperature setting can thereby be obtained as desired from the room temperature measured by the intermediary device or the room temperature measured by the indoor units.

In the air conditioning control method according to the eleventh aspect, separate air conditioners can thereby be introduced using an air conditioning interface for existing central air conditioning, and a pleasant air conditioning environment can be provided in response to an imbalance in the air conditioning load.

In the air conditioning control program according to the twelfth aspect, separate air conditioners can thereby be introduced using an air conditioning interface for existing central air conditioning, and a pleasant air conditioning environment can be provided in response to an imbalance in the air conditioning load.

### BRIEF DESCRIPTION OF THE DRAWINGS

FIG. 1 is a general view of an air conditioning control system according to a first embodiment;

FIG. 2 is a schematic structural diagram of an intermediary device according to the first embodiment;

FIG. 3A is a view of the external appearance of the display unit of the thermostat according to the first embodiment;

FIG. 3B is a diagram showing a correspondence chart of the operation mode and the output signal of the thermostat according to the first embodiment;

FIG. 4 is a flowchart showing the process flow of the intermediary device according to the first embodiment;

FIG. 5 is a diagram showing a cooling operation initiated by the thermostat according to the first embodiment;

FIG. 6 is a general view of an air conditioning control system according to modification D of the first embodiment;

FIG. 7 is a general view of an air conditioning control system according to modification E of the first embodiment;

FIG. 8 is a schematic structural diagram of an intermediary device according to a second embodiment;

FIG. 9A is a flowchart showing the first half of the process flow of the intermediary device according to the second embodiment;

FIG. 9B is a flowchart showing the second half of the process flow of the intermediary device according to the second embodiment; and

FIG. 10 is a diagram showing a cooling operation initiated by the thermostat according to the second embodiment.

### EXPLANATION OF THE REFERENCE NUMERALS

1 air conditioning control system
10 intermediary device
11 receiving unit
12 room temperature acquisition unit
13 temperature-setting estimating unit
14 storage unit
15 transmitting unit
19 controlling unit
20 thermostat (air conditioning interface)
30 outdoor unit
33 refrigerant passage
34 communication line
40 indoor unit
41 temperature sensor
210 intermediary device
211 receiving unit
213 temperature-setting estimating unit
214 storage unit
215 transmitting unit
216 timer
217 temporary temperature setting unit

### BEST MODE FOR CARRYING OUT THE INVENTION

### First Embodiment

### <Overall Configuration of the air Conditioning System>

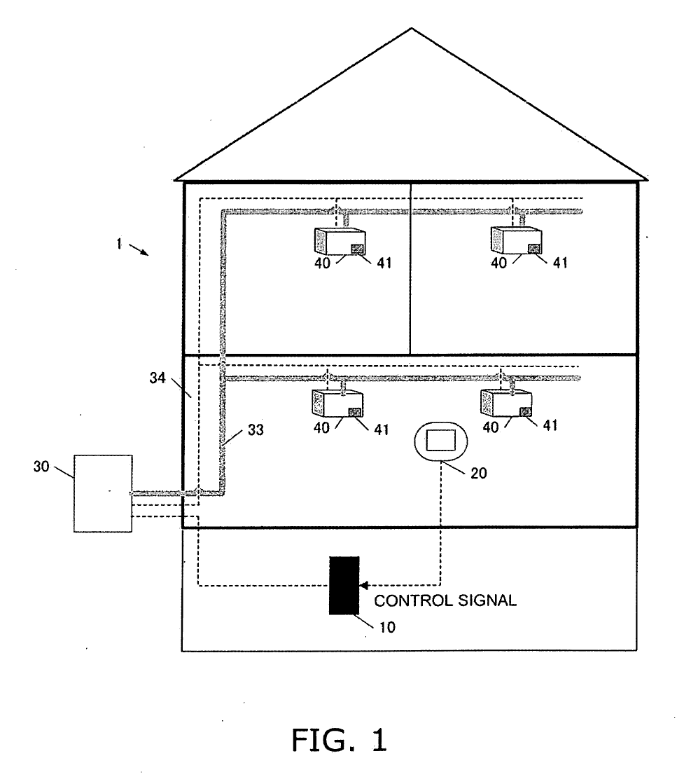

FIG. 1 shows an air conditioning system according to a first embodiment of the present invention. An air conditioning system 1 is mainly composed of an intermediary device 10 a thermostat 20 as an air conditioning interface, and air conditioners including an outdoor unit 30 as a heat source and indoor units 40 for separate air conditioning. In the present embodiment, the most easily implemented example is provided as a mode in which separate air conditioners are introduced to a central air-conditioning apparatus in which an air conditioning interface such as a thermostat is used.

The intermediary device 10 receives a control signal as input from the thermostat 20, converts the signal to a predetermined signal as described below, and transmits the predetermined signal to the air conditioners. The outdoor unit 30 and the indoor units 40 are connected via a refrigerant passage 33. The intermediary device 10 and the air conditioners are communicably connected via a communication line 34.

The thermostat 20 transmits a control signal for making an operation/non-operation request to a compressor (not shown) of the outdoor unit 30 on the basis of the temperature setting. The outdoor unit 30 and the indoor units 40 are air conditioners for implementing separate air conditioning. With separate air conditioning for each room, operations are performed including adjusting the flow rate of the refrigerant that has undergone heat exchange in the outdoor unit 30 and sent via the refrigerant passage 33. A temperature sensor 41 is provided to each indoor unit 40. The temperature sensor 41 measures the room temperature and transmits the measured room temperature information to the intermediary device 10.

### <Configuration of the Intermediary Device>

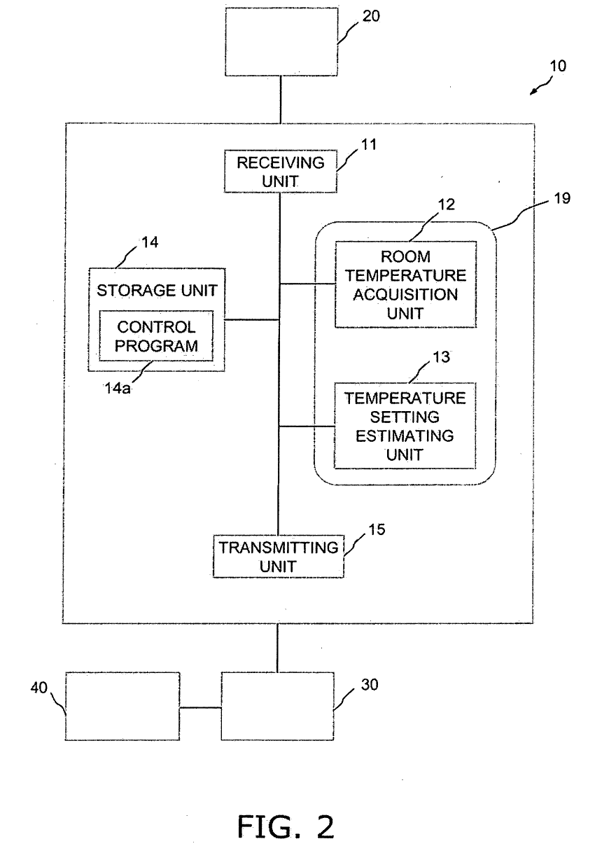

The intermediary device 10 has a receiving unit 11, a room temperature acquisition unit 12, a temperature-setting estimating unit 13, a storage unit 14, and a transmitting unit 15, as shown in FIG. 2. The receiving unit 11 receives a control signal as input from the thermostat 20, and receives room temperature information or the like from the air conditioners. The room temperature acquisition unit 12 acquires room temperature information that is acquired via the receiving unit 11. The temperature-setting estimating unit 13 calculates an estimated temperature setting from the control signal from the thermostat 20 as described below. The transmitting unit 15 transmits signals generated in the temperature-setting estimating unit 13 or the like to the air conditioners.

A controlling unit 19 has the room temperature acquisition unit 12 and the temperature-setting estimating unit 13, and is composed of a CPU and the like. The storage unit 14 is composed of an internal memory such as a RAM and a ROM, or an external memory such as a hard disk. The storage unit 14 stores a control program 14a that is used by a later-described intermediary device 10 to execute control processes.

### <Function of the Thermostat>

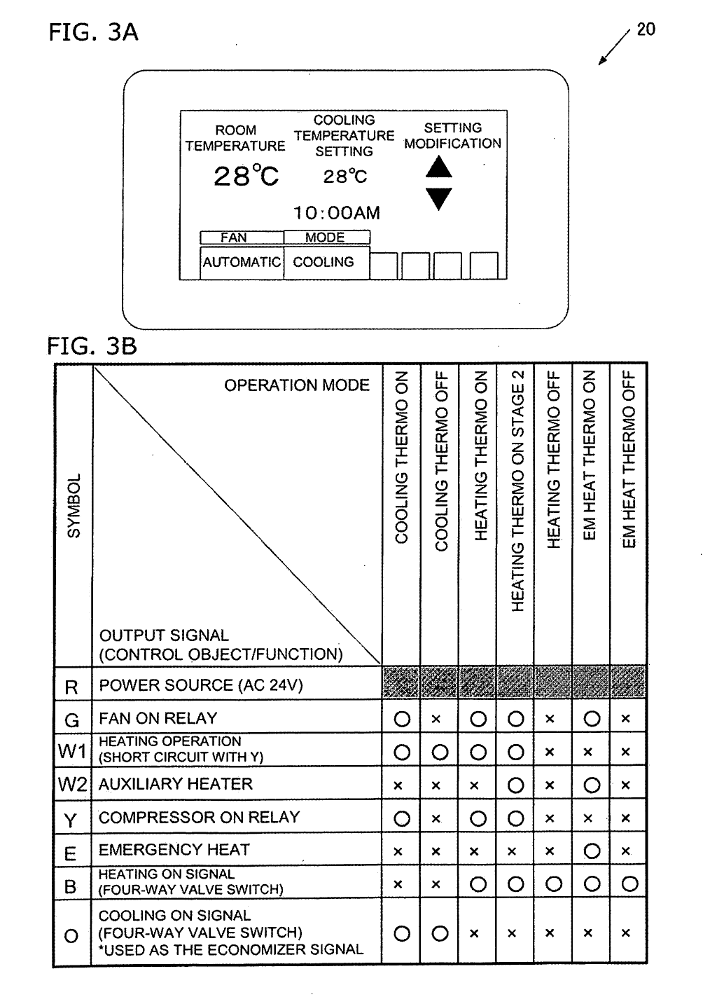

Here, the function of the thermostat 20 will be described. FIG. 3A shows an example of the thermostat display unit. FIG. 3B is a table showing the correspondence between the output signal of the thermostat and the operation mode.

The thermostat 20 is widely used as an air conditioning control interface, particularly in European and American homes or the like, and has a function for maintaining room temperature, a function for setting the temperature setting a function for turning the fan on and off, a function for setting cooling and heating, as well as other functions. The thermostat 20 is operated in accordance with a display interface as shown in FIG. 3A, whereby a signal is outputted to a heat source, and functions such as those described above are implemented.

FIG. 3B is a table showing a correspondence between the signals outputted from the thermostat 20 by such an above mentioned operation and the operation modes. In the present embodiment, a temperature setting required by the air conditioners is estimated from changes in the output signals from the thermostat 20.

The air conditioning system of the present invention thus provides a pleasant air conditioning environment for all rooms by using a thermostat, which is the de-facto standard for a man-machine interface for air conditioners in Europe and the United States and separate air conditioners. The thermostat 20 outputs signals (Fan ON/OFF, Heating operation, Auxiliary heater ON/OFF, Compressor ON/OFF, Emergency heat ON, Heating ON, Cooling ON, and the like) such as those shown in FIG. 3B. On the other hand, in separate dispersed air conditioners, examples of control signals that can be used for control include operation/stop, operation mode (cooling, heating, ventilation), temperature setting, air flow (High, Low, Auto), and capacity control (100%, 70%, 40%, 0%), and independent control is possible. In the present embodiment, the temperature setting to be set in the air conditioners is estimated based on the ON/OFF signal of the compressor.

### <Process Flow of the Intermediary Device>

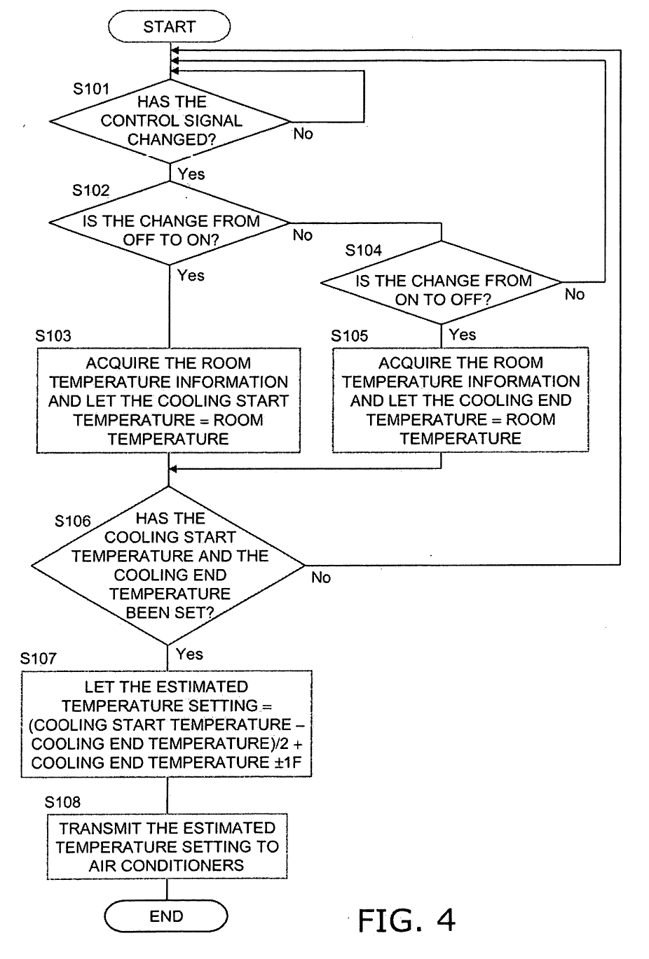

FIG. 4 shows the flow of the cooling operation as carried out by the thermostat 20. The process flow carried out by the intermediary device 10 will be described with reference to the same diagram.

First, the intermediary device 10 determines (step S101) whether a change has occurred in the control signal (e.g., compressor ON signal Output) from the thermostat 20. Specifically, in a case in which the compressor has been switched on, and in a case in which the compressor is, conversely, switched off, it is determined whether a change has occurred in the control signal outputted from the thermostat 20 from the time the earlier change was detected. The process returns to the start in a case in which the control signal has not changed.

When the control signal has changed, it is determined (step S102) whether the change is from off to on. If the change is from off to on, the room temperature information is acquired from the room temperature acquisition unit 12 and the room temperature is set to a cooling start temperature (step S103).

When the change is not from off to on, it is determined (step S104) whether the change is from on to off. If the change is from on to off, the room temperature information is acquired from the room temperature acquisition unit 12, and the room temperature is set to the cooling end temperature (step S105). The process returns to the start in a case in which the control signal has not changed from on to off.

Next, the temperature-setting estimating unit 13 determines whether the cooling start temperature and the cooling end temperature have both been set (step S106). When the cooling start temperature or the cooling end temperature has not be set, the process returns to the start of the process. When the cooling start temperature and the cooling end temperature have both been set, the temperature-setting estimating unit 13 calculates (step S107) an estimated temperature setting. Specifically, a differential of about ±1F is added to the numerical value (78F in this case) obtained by adding the cooling end temperature to a value obtained by dividing the difference between the cooling start temperature and the cooling end temperature by two. The estimated temperature setting obtained in this manner is transmitted to each air conditioner (step S108).

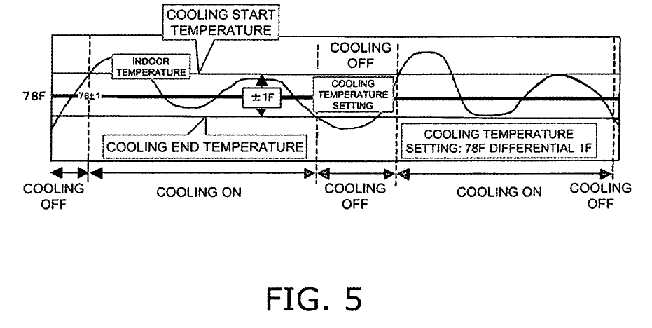

FIG. 5 is a graph showing the relationship between the room temperature and the estimated temperature setting When the room temperature is high, the cooling (compressor) is switched on by the control signal from the thermostat 20. Therefore, the intermediary device 10, which has detected the change in the control signal to ON, uses the room temperature thus obtained as the cooling start temperature. Since the room temperature is reduced by switching on the cooling, the cooling is switched off by the control signal from the thermostat 20 after a set length of time. The intermediary device 10, which has detected the change to OFF, sets the room temperature thus obtained as the cooling end temperature. In this manner, an approximation value of the temperature setting can be produced from the control signal for requesting an ON/OFF operation of the cooling outputted from the thermostat 20 in accompaniment with fluctuations in the room temperature.

In the present embodiment, the temperature setting is estimated using the room temperature in the interval from the switching on of the cooling to the switching off, but the temperature setting can be similarly estimated using the room temperature in the interval from the switching off of the cooling to the switching on.

### <Features of the Air Conditioning System According to the First Embodiment>

(1) In the air conditioning system 1 according to the first embodiment, separate air conditioners can thereby be introduced using an air conditioning interface for existing central air conditioning, and a pleasant air conditioning environment can be provided in response to an imbalance in the air conditioning load, because a temperature setting approximate to the actual temperature setting can be calculated as the temperature setting required for separate air conditioning control by the outdoor unit 30 and the indoor units 40 based on the control signal from the thermostat 20.

In other words, separate air conditioning, which could not be implemented conventionally in central air conditioning using a thermostat, can be implemented by setting the relative temperature difference between the temperature settings from the thermostat for each indoor unit.

(2) Thermostats have a variety of output signals depending on the type, but any type of thermostat can be used because the temperature setting is estimated using basic output signals in the present embodiment.

### <Modification of the First Embodiment>

(A) In the first embodiment, cooling operation was used as an example, but similar application can also be made to a heating operation. In the heating operation, the heating start temperature and the heating end temperature are measured according to the output timing of the heater control signal of the thermostat 20 to allow the heating temperature setting to be estimated.

Automatic changeover is one function of a thermostat. The function operates while automatically switching between cooling, off, and heating, and maintains the temperature setting when the mode is set to Auto and the temperature setting of the cooling and the heating is established. The embodiment described above can be applied even in such a setting.

(B) In the first embodiment, the estimated temperature setting may be obtained by calculating the mean value. For example, in this case, the estimated temperature setting is calculated by computing a formula such as “(Mean value of the cooling start temperature—Mean value of the cooling end temperature)/2+Mean value ±1F of the cooling end temperature.” Also, the calculation can be made using the weighted mean value, the mode value, the median value, or the like.

(C) In the first embodiment, the intermediary device 10 acquires the room temperature information from the indoor units 40, but the room temperature information may be acquired from a temperature sensor disposed in the intermediary device 10 or from a temperature sensor connected to the intermediary device 10.

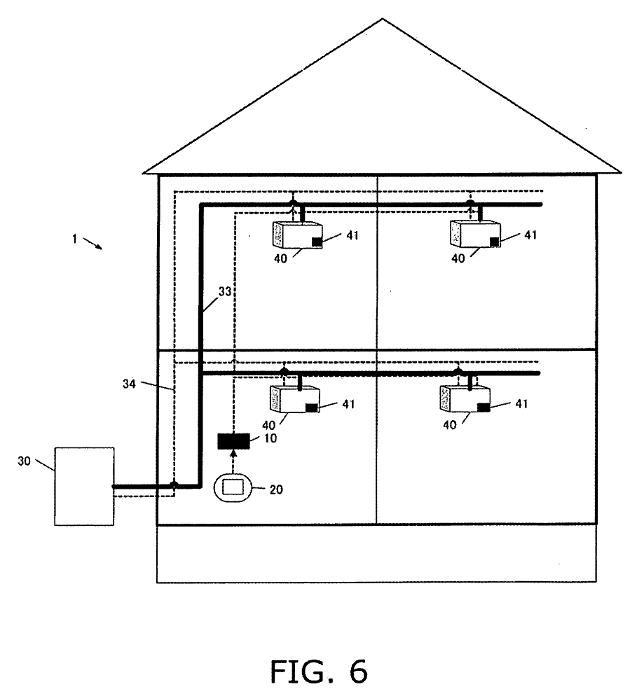

(D) The control signal inputted to the intermediary device 10 from the thermostat 20 may be converted and transmitted to the indoor units 40 rather than the outdoor unit 30. In other words, the intermediary device 10 may be connected to a plurality of indoor units 40, as shown in FIG. 6, and the control signal from the thermostat 20 may be converted by the intermediary device 10 and transmitted to the indoor units 40. In this case as well, centralized control of a plurality of the indoor units 40 can be carried out in the thermostat 20 in the same manner as in the first embodiment.

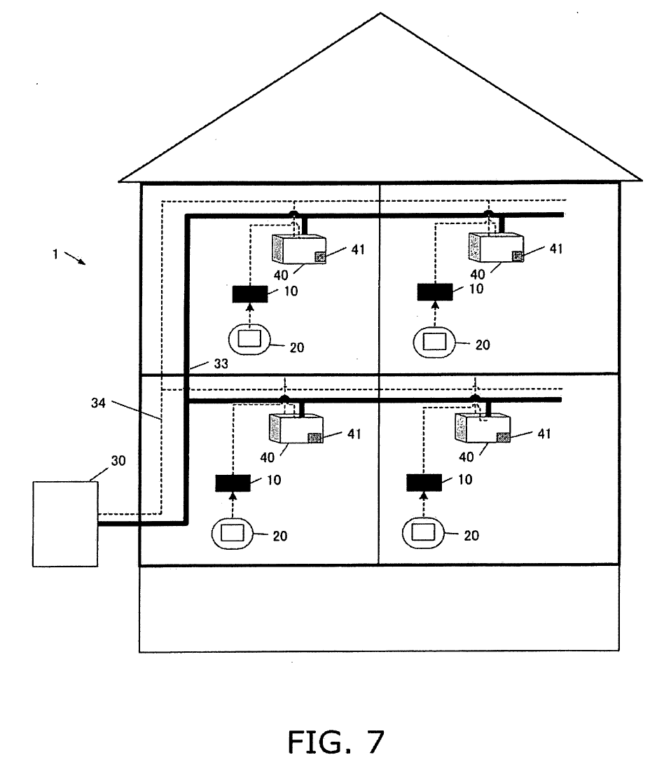

(E) The thermostats 20 and the intermediary devices 10 may be provided in accordance with the number of indoor units 40, and each indoor unit 40 may receive a control signal from the single thermostat 20 as converted by the single intermediary device 10. In other words, the single thermostat 20 and the single intermediary device 10 may each be provided to a plurality of the indoor units 40, and each of the intermediary devices 10 may transmit to the air conditioners the control signal received and converted as input from the thermostats 20 connected to the respective intermediary devices, whereby the indoor units 40 are controlled. FIG. 7 is an example in which the intermediary devices 10 and the indoor units 40 are directly connected, and control signals from the thermostats 20 are converted by the intermediary devices 10 and transmitted to the indoor units 40. In this case, operation can be carried out at a different temperature setting for each of the indoor units 40 by using a different setting for each of the thermostats 20.

(F) Each indoor unit 40 may be provided with a remote control. The estimated temperature setting based on the output signal from the thermostat 20 and the temperature setting inputted by a separate remote control may be selected in a case in which a remote control has been set for each of the indoor units 40. A pleasant air conditioning environment can thereby be implemented in a flexible manner.

(G) The air conditioning system 1 according to the first embodiment is mainly composed of the intermediary device 10, the thermostat 20 as an air conditioning interface, and air conditioners including the outdoor unit 30 as a heat source and the indoor units 40 for performing separate air conditioning. However, it is possible to additionally include a heating coil (not shown), a gas furnace (not shown), and other heating apparatuses, as well as a damper for an outside air inlet (not shown). In other words, a heating coil, a gas furnace, or other heating apparatuses, as well as a damper for an outside air inlet may be communicably connected to the thermostat 20 and operate when a control signal is received from the thermostat 20. In this case, heating apparatus such as a heating coil and a gas furnace and a damper for an outside air inlet can be used together with air conditioners. For example, when the outside temperature is at a predetermined level or less; heating apparatus such as the heating coil and the gas furnace can be actuated, or when the outside air temperature has become less than the room temperature at night, cold outside air can be drawn into a room using the damper. Therefore, a pleasant air conditioning environment can be obtained with good efficiency.

(H) In the first embodiment, the intermediary device 10 estimates the temperature setting using the operation control signal sent to the compressor of the outdoor unit 30, but the temperature setting may be estimated using another output signal, as shown in FIG. 3B. For example, the condition in which air conditioning is comfortably performed using a thermostat is one in which the fan is stopped and the compressor and the heater are off when the fan operates in “AUTO” mode. Alternatively, this is a condition in which the compressor and the heater are off when the fan operates in “ON” mode. The temperature setting can be estimated by obtaining such an output signal.

### Second Embodiment

### <Overall Configuration of the air Conditioning System>

The air conditioning system according to the second embodiment is mainly composed of an intermediary device 210, a thermostat 220, and air conditioners including an outdoor unit 230 and indoor units 240. The overall configuration of the system is the same as the air conditioning system 1 according to the first embodiment, and a description is therefore omitted.

### <Configuration of the Intermediary Device>

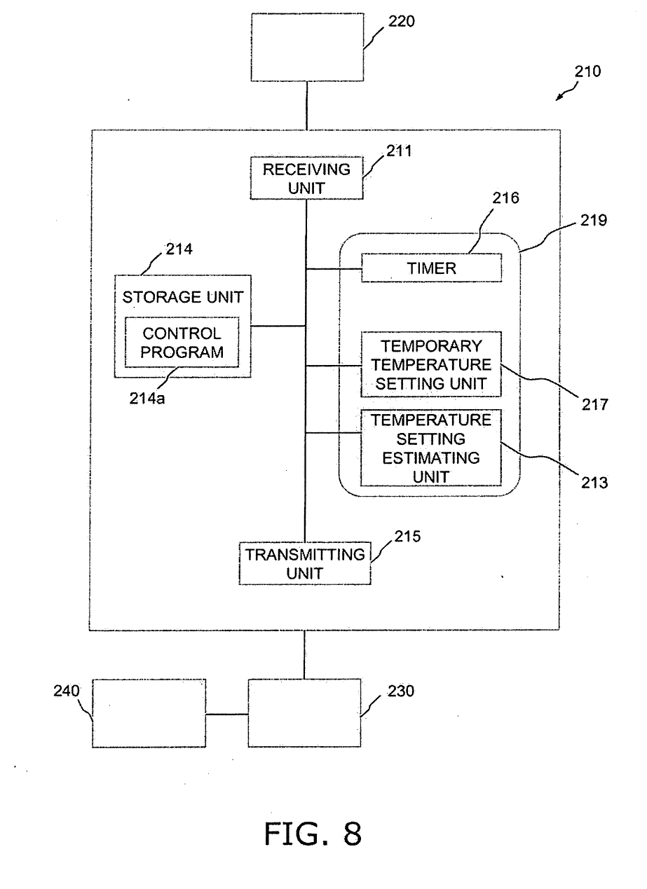

FIG. 8 shows the intermediary device 210 according to the second embodiment.

The intermediary device 210 has a receiving unit 211, a temperature-setting estimating unit 213, a timer 216, a temporary temperature setting unit 217, a storage unit 214, and a transmitting unit 215. The receiving unit 211 receives a control signal or the like as input from the thermostat 220. The timer 216 measures the time during which operation has continued using the temporary temperature setting as described below. The temporary temperature setting unit 217 determines a temporary temperature setting. The temperature-setting estimating unit 213 calculates an estimated temperature setting from the temporary temperature setting and the control signal from the thermostat 220. The transmitting unit 215 transmits control signals generated in the temperature-setting estimating unit 213 or the like to the air conditioners.

A controlling unit 219 has the temperature-setting estimating unit 213, the timer 216, and the temporary temperature setting unit 217, and is composed of a CPU and the like. The storage unit 214 is composed of all internal memory such as a RAM and a ROM, or an external memory such as a hard disk. The storage unit 214 stores a control program 214a that is used by the intermediary device to execute control processes described below.

### <Process Flow of the Intermediary Device>

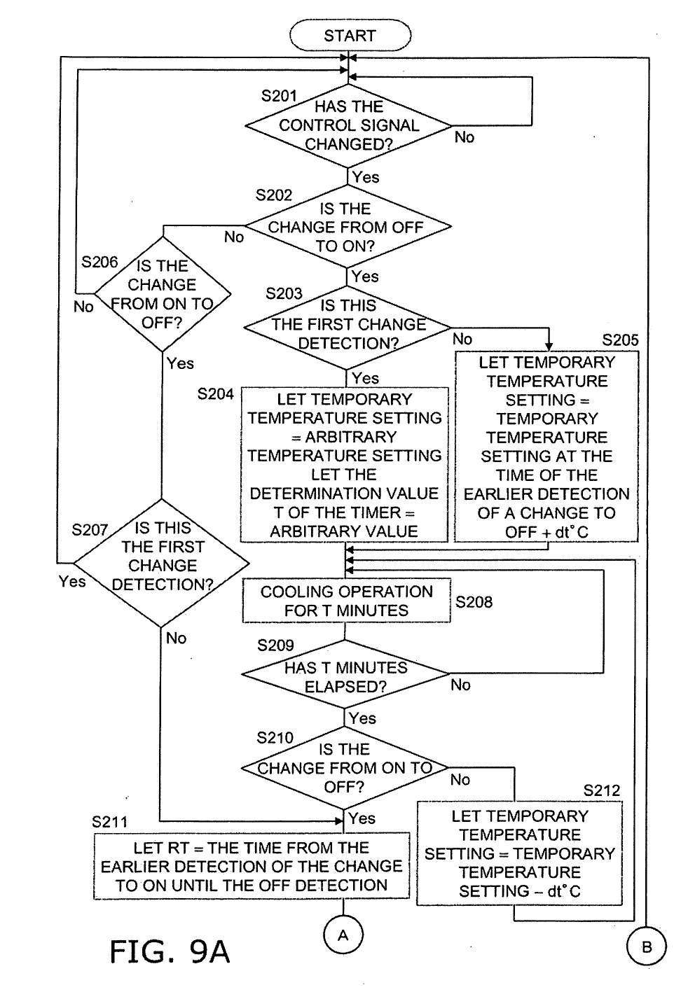

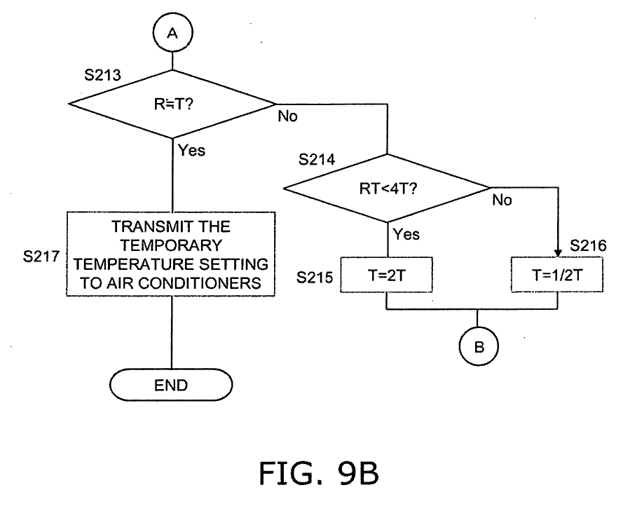

FIGS. 9A and 9B show the flow of the cooling operation as carried out by the thermostat 220. The process flow carried out by the intermediary device 210 will be described with reference to the same diagrams.

First, the intermediary device 210 determines (step S201) whether a change has occurred in the control signal (e.g., compressor ON signal output) from the thermostat 220, as shown in FIG. 9A. Specifically, in a case in which the compressor has been switched on, and in a case in which the compressor is, conversely, switched off, it is determined whether a change has occurred in the control signal outputted from the thermostat 220 from the time the earlier change was detected. The process returns to the start in a case in which the control signal has not changed.

When the control signal has changed, it is determined (step S202) whether the change is from off to on. If the change is from on to off, it is determined whether the detected change is the first change (step S203). If the detection is the first detection, any temperature setting is set as the temporary temperature setting, and a determination value T of the timer 216 is set to an arbitrary value (step S204). If the detection is not the first detection, the temporary temperature setting is set (step S205) to a value obtained by adding dt° C. to the temporary temperature setting obtained at the time when a change back to OFF was detected.

It is also determined (step S206) whether the change is from on to off when the change is not from off to on in step S202. When the change is from on to off, it is determined (step S207) whether the change detection is the first detection. If the detection is the first detection, the process returns to the start, and if the detection is not the first detection, the process proceeds to step S211.

Following step S204, a cooling operation is carried out (step S208) for a number of minutes commensurate to the determination value T of the timer 216, and it is determined (step S209) whether T minutes have elapsed. In a case in which T minutes have elapsed, it is determined (step S210) whether a change from on to off has been detected. In a case in which a change to OFF has been detected, a round time RT is set (step S211) as the time from the earlier detection of the change to ON to the time of the detection of the change to OFF. The time is measured by the timer 216. When a change to OFF has not been detected, the temporary temperature setting is set (step S212) to the value of “temporary temperature setting—dt° C.,” the process returns to step S208, and the cooling operation is carried out for T minutes.

Following the processing of step S211, it is determined (step S213) whether RT and T substantially match with each other, as shown in FIG. 9B. When there is a match, the temporary temperature setting is transmitted (step S217) to the air conditioners as the estimated temperature setting. When there is not a match, it is determined (step S214) whether RT is less than 4T. When RT is less than 4T, T is set (step S215) to 2T; and when RT is 4T or greater, T is set (step S216) to ½T, and the process is restarted.

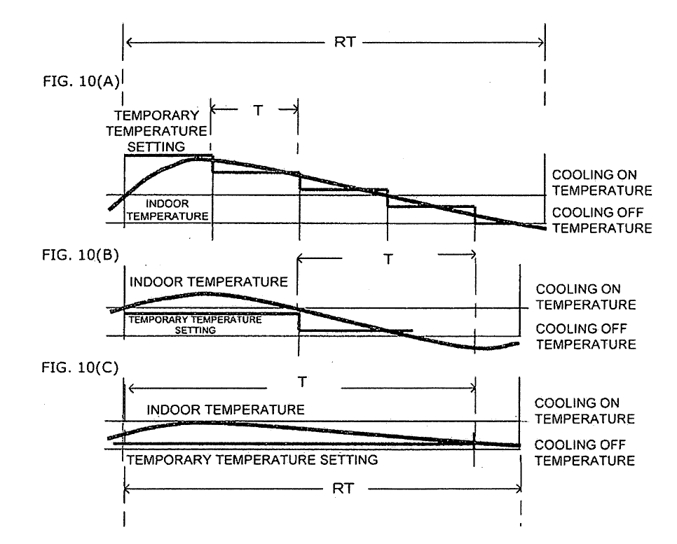

The graphs (A) to (C) shown in FIG. 10 show the relationship between the room temperature and the temporary temperature setting obtained as a result of having carried out the processes shown in FIGS. 9A and 9B as described above. In (A), the initial temporary temperature setting is excessively high, and a change to OFF is not detected based on the control signal from the thermostat 220, even when T minutes have elapsed. Therefore, the temporary temperature setting is gradually reduced (the loop processing of S208 to S212 of FIG. 9A is performed). Once a change to OFF has been detected. RT is recorded (same in step S211), T is replaced (steps 214 to S216), and the same process is repeated again.

In (A) of FIG. 10, since RT, which is the round time from on to off, is 4T or greater, in the next process, T is substituted with ½T and the process is carried out again. In (B), since RT is less than 4T, in the next process. T is substituted with 2T and the process is carried out again. As a result, in (C), RT and T substantially match with each other, and the temporary temperature setting thereby becomes an approximate value of the actual temperature setting.

### <Features of the air Conditioning System According to the Second Embodiment>

In addition to the features of the first embodiment, the system according to the second embodiment described above can be introduced in a simpler manner and at lower cost because the intermediate device 210 can estimate the temperature setting of the thermostat without the need to obtain the room temperature information.

### <Modification of the Second Embodiment>

In the second embodiment described above, it is determined in step S203 of FIG. 9A whether the detection of the change to on is the first change, but the determination can be made using the timer 216.

Specifically, the time (provisionally referred to as RT2) after the change to OFF has been detected from the thermostat 220 until the change to ON is thereafter detected again is measured by the timer 216 and stored. When RT2 is a set value or greater, it is determined that the change to ON in step S203 has been made for the first time. A file is furthermore created and stored in which the relationship between determination values and outside air temperatures acquired in advance is defined. And an arbitrary value is used, as the value of the determination value T of the timer in step S204, in accordance with the outside temperature.

Particularly, in a case in which the air conditioners have not operated for a set length of time, it is sometimes more suitable to obtain an initial value again rather than assuming that the temperature setting of the indoor units is equal to the temporary temperature setting+dt° C. in step S205, where the temporary temperature setting is a value obtained during the earlier detection of the change to OFF, as in the second embodiment described above. For example, when the cooling or heating operation is stopped in an intermediate interval during automatic changeover operation, it is best not to use the previous value because the season has changed.

### INDUSTRIAL APPLICABILITY

The present invention has an effect in which separate air conditioning is implemented using the air conditioning interface of existing central air conditioning, such as the thermostat, and a pleasant air conditioning environment can be provided in response to an imbalance in the air conditioning load, and is useful as an intermediary device for air conditioning control, an air conditioning control system, an air conditioning control method, and an air conditioning control program.

1. An intermediary device for air conditioning control, the device being connected to an air conditioning interface to output an operation/non-operation request signal to a heat source on the basis of a room temperature and a temperature setting, the intermediary device comprising:
a receiving unit being configured to receive the operation/non-operation request signal as input;
a temperature-setting estimating unit being configured to calculate an estimated value of the temperature setting oil the basis of at least the operation/non-operation request signal; and
a transmitting unit being configured to transmit to air conditioners the estimated value calculated in the temperature-setting estimating unit.

2. The intermediary device according to claim 1, further comprising
a room temperature acquisition unit provided to acquire the room temperature, wherein
the temperature-setting estimating unit calculates the estimated value of the temperature setting using the room temperature and the operation/non-operation request signal.

3. The intermediary device according to claim 2, wherein the room temperature acquisition unit acquires the room temperature via indoor units constituting the air conditioners.

4. The intermediary device according to claim 1, wherein the operation/non-operation request signal is a signal that requests operation and non-operation of a heater or a compressor of the heat source.

5. The intermediary device according to claim 3, wherein the temperature-setting estimating unit calculates as the estimated value an optimum value of the room temperature in a period from the time that the operation signal is outputted to the time that the non-operation signal is outputted, or in a period from the time that the non-operation signal is outputted to the time that the operation signal is outputted.

6. The intermediary device according to claim 1, further comprising
a temporary temperature setting unit that determines a temporary temperature setting, and
a time measurement unit that measures the time from the time that the operation signal is outputted to the time that the non-operation signal is outputted, or from the time that the non-operation signal is outputted to the time that the operation signal is outputted, wherein
the temperature-setting estimating unit further calculates the estimated value on the basis of the temporary temperature setting and the measured time.

7. An air conditioning control system, comprising:
the intermediary device of claim 1;
the air conditioning interface being configured to communicate with the intermediary device; and
air conditioners having an outdoor unit and indoor units being configured to receive control signals from the intermediary device,
the indoor units controlling air conditioning on the basis of an estimated value of the temperature setting thus received.

8. The air conditioning control system according to claim 7, wherein
the indoor units are disposed in a plurality of rooms, and
the air conditioning interface and the intermediary device are provided in accordance with the number of the indoor units disposed in the plurality of rooms, and transmit the estimated value of the temperature setting to each of the indoor units.

9. The air conditioning control system according to claim 7, wherein
the indoor units are disposed in a plurality of rooms, and
the air conditioning interface and the intermediary device transmit the estimated value of the temperature setting collectively to a plurality of the indoor units disposed in the plurality of rooms.

10. The air conditioning control system according to claim 9, wherein the intermediary device measures the room temperature using a temperature sensor connected to the intermediary device or receives the room temperature measured by a temperature sensor disposed in the indoor unit.

11. An air conditioning control method that uses an air conditioning interface to output an operation/non-operation request signal to a heat source on the basis of a room temperature and a temperature setting, the air conditioning control method comprising:
receiving the operation/non-operation request signal as input from the air conditioning interface;
calculating an estimated value of the temperature setting on the basis of at least the operation/non-operation request signal; and
transmitting to air conditioners the calculated estimated value of the temperature setting.

12. An air conditioning control program for carrying out in a computer air conditioning control that uses an air conditioning interface to output an operation/non-operation request signal to a heat source on the basis of a room temperature and a temperature setting, the air conditioning control program comprising:
receiving the operation/non-operation request signal as input from the air conditioning interface;
calculating an estimated value of the temperature setting on the basis of at least the operation/non-operation request signal; and
transmitting to air conditioners the calculated estimated value of the temperature setting.

13. The intermediary device according to claim 2, wherein the temperature-setting estimating unit calculates as the estimated value an optimum value of the room temperature in a period from the time that the operation signal is outputted to the time that the non-operation signal is outputted, or in a period from the time that the non-operation signal is outputted to the time that the operation signal is outputted.

14. The air conditioning control system according to claim 8, wherein the intermediary device measures the room temperature using a temperature sensor connected to the intermediary device or receives the room temperature measured by a temperature sensor disposed in the indoor unit.

15. The air conditioning control system according to claim 7, wherein the intermediary device measures the room temperature using a temperature sensor connected to the intermediary device or receives the room temperature measured by a temperature sensor disposed in the indoor unit.
